(19) United States
(12) Patent Application Publication
(10) Pub. No.: US 2018/0308027 A1
(43) Pub. Date: Oct. 25, 2018

(54) APPARATUS AND METHOD FOR DETERMINING AND RENDERING RISK ASSESSMENTS TO USERS

(71) Applicant: General Electric Company, Schenectady, NY (US)

(72) Inventors: Jason Cline, Roanoke, VA (US); Diwakar Kasibhotla, San Ramon, CA (US)

(21) Appl. No.: 15/496,198

(22) Filed: Apr. 25, 2017

(51) Int. Cl. G06Q 10/06

(52) U.S. Cl. CPC G06Q 10/0635

(57) ABSTRACT

A risk assessment associated with an industrial machine or component of the machine is performed. A trigger message is received from the industrial machine. When the trigger message is received, a hyperlink is dynamically rendered to a user on a display. A user selects the hyperlink by a user. When the hyperlink is selected by the user, a dynamic risk assessment display is rendered on a display device to the user, and the risk assessment display communicating the risk assessment.

### BACKGROUND OF THE INVENTION

### Field of the Invention

The subject matter disclosed herein generally relates risk assessment and, more specifically, to determining and rendering risk assessment information to users.

### Brief Description of the Related Art

Various types of industrial machines are used to perform various manufacturing operations and tasks. For instance, some machines are used to create and finish parts associated with wind turbines. Other machines are used to create mechanical parts or components utilized by vehicles. Still other machines are used to produce electrical parts (e.g., resistors, capacitors, and inductors to mention a few examples).

In other cases, the machines are not used as part of a manufacturing process, but provide other functions. For instance, the machines themselves may be wind turbines, which convert wind energy into electrical power. Typically, industrial machines are controlled at least in part by computer code (or a computer program) that is executed by a processor that is located at the machine.

The machines often have sensors that measure (or sense) various types of data. For example, temperature, pressure, and speed information may be measured. The sensed information can be used by analytics. Analytics are typically computer programs that operate on the data to provide various results to users. In one example, an analytic may determine the efficiency of a machine or a group of machines. Other analytics can use the data to make predictions of future machine performance.

During machine operation, one type of information that machine operators (and others) desire to view is risk. “Risk” may involve the risk that a particular machine or component within the machine will fail. “Risk” might also involve the consequences of a component failure. For example, within an industrial or factory context it may be desirable to understand whether the failure of one machine (or component within the machine) would cause other machines (or components) to fail. “Risk” can also involve different types of parameters. For example, financial, health, safety, and other types of risk exist.

### BRIEF DESCRIPTION OF THE INVENTION

The present invention is directed to the determination and/or presentation of views of risks to users. These approaches are easier to implement than prior techniques for presenting dynamic risk views to users. Consequently, uninterrupted operation of the machines (and processes using the machines) is promoted leading to improved financial efficiencies and rewards for those owning or operating the machines.

More specifically, risk assessment is integrated with machine maintenance with operations performed at a central processing center. The processing center provides multi-dimensional views of risk to users, based on real-time data, allowing risk mitigation actions (e.g., maintenance actions) to be performed before alerts (identifying a problem or potential problem at a machine) need to be (or are) issued. In aspects, analysis of the real-time data avoids future problems, such as catastrophic failures of industrial machines, before these problems arise. The real-time aspect of the data analysis allows a dynamic view of risk to be presented to a user. Different types of views of risk (risk assessments) can be rendered to users, such as dashboards or various types of screens or displays.

In many of these embodiments, a risk assessment associated with an industrial machine or component of the machine is performed. A trigger (e.g., an alert message) is received from the industrial machine. When the trigger is received, a hyperlink is dynamically rendered to a user on a display. A user selects the hyperlink. When the hyperlink is selected by the user, a dynamic risk assessment display is rendered on a user display device to the user, and the risk assessment display communicates the risk assessment to the user.

In some aspects, risk assessment includes assessing the risk of failure of industrial machines or components thereof. In other aspects, the risk is an environmental, financial, operational, health, or safety risk. In examples, a trigger message is sent from an industrial machine and received by a central processing center. In one example, the trigger message is sent over the cloud to the central processing center.

The display device may be any type of device capable of rendering a display to a user such as a computer or smartphone. Other examples of devices are possible.

In other aspects, the risk assessment display is a matrix, such as a two-dimensional graph. The matrix has an x-axis representing the probability of having a problem and the y-axis represents the consequence if the problem occurs. Other examples of displays are possible.

In others of these embodiments, an apparatus that is configured to determine the risk of failure of an industrial machine or components of a machine includes an interface and a control circuit. The interface has an input and an output, and the input is configured to receive the trigger from the industrial machine.

The control circuit is coupled to the interface. The control circuit is configured to determine a risk assessment, and, upon receiving the trigger, dynamically render a hyperlink to a user via the output of the interface. The control circuit is configured to receive a selection of the hyperlink by the user via the input of the interface, and when the hyperlink is selected by the user, render a dynamic risk assessment display defining the risk assessment on a display device to the user via the output of the interface.

### BRIEF DESCRIPTION OF THE DRAWINGS

For a more complete understanding of the disclosure, reference should be made to the following detailed description and accompanying drawings wherein:

FIG. 1 comprises a block diagram showing a system allowing the dynamic assessment of risk according to various embodiments of the present invention;

FIG. 2 comprises a flowchart showing one approach for dynamically assessing and rendering a view of risk to a user according to various embodiments of the present invention;

FIG. 3 comprises a processing apparatus according to various embodiments of the present invention;

FIG. 4 comprises one example of an approach for determining the relative amount of risk that a component or machine will fail according to various embodiments of the present invention;

FIG. 5 comprises a flow chart showing an approach for evaluating the severity of consequence associated with machine and/or component failure according to various embodiments of the present invention;

FIG. 6 comprises examples of risk assessment displays according to various embodiments of the present invention;

FIG. 7 comprises another example of risk assessment displays according to various embodiments of the present invention; and

FIG. 8 comprises a call flow diagram showing communications between various system elements according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

The present approaches are directed to assessing risks associated with the operation of industrial machines and visually rendering these assessments in meaningful ways to users. A user can, by viewing the information presented, easily and quickly determine and/or identify risks associated with machine operation, and prevent component, machine, or system failure before such failures occur. In so doing, the operation of the machines (and facilities in which these machines are deployed) is made more efficient, and shutdowns of processes that utilize these machines is minimized, and in some cases, eliminated.

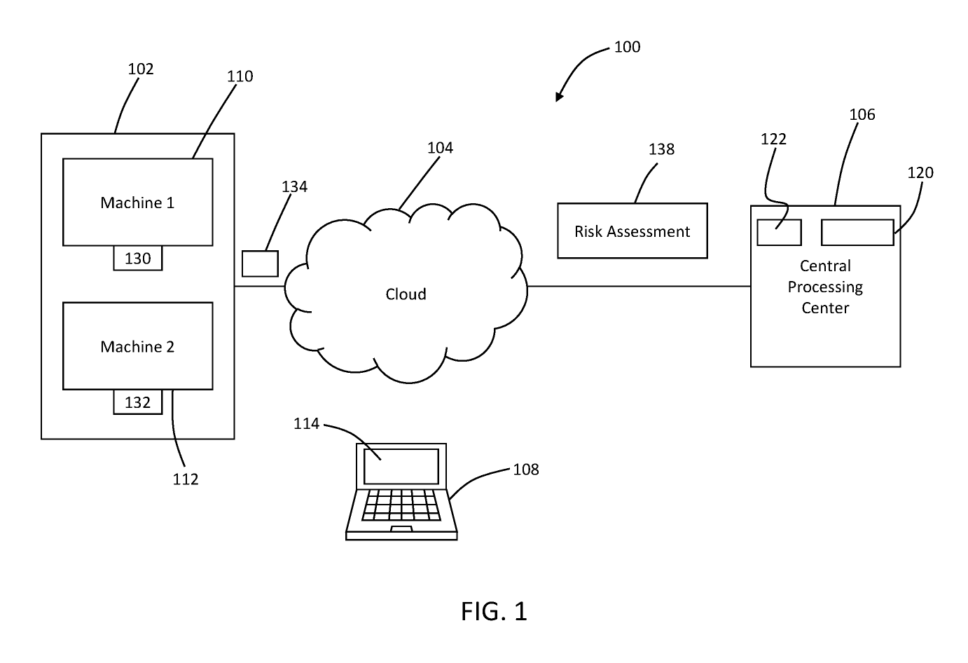

Referring now to FIG. 1, one example of a system 100 that is configured to perform a risk assessment associated with an industrial machine or component of the machine is described. The system includes an installation 102, a network 104, and a central processing center 106. A user display device 108 is coupled to the network 104.

The installation 102 may be any grouping of one or more industrial machines. In some aspects, the installation 102 may be a factory, school, campus, office building, or other facility housing industrial equipment. Other examples of installations are possible.

The installation 102 includes a first industrial machine 110 and a second industrial machine 112. Although two machines are shown here, it will be appreciated that any number of machines can be used (e.g., one machine, or more than two machines). The first industrial machine 110 and second industrial machine 112 may be any type of machine or device. In some examples, the first industrial machine 110 and second industrial machine 112 may be a wind turbine, grinder, robot, furnace, computer, controller, or boiler. Other examples of industrial machines are possible.

The machines 110, 112 operate at or within the installation 102. In some aspects, the machines 110, 112 constantly collect data related to various parameters (e.g., temperature, pressure, or speed) using sensors 130 and 132. In other aspects, and when deviations from expected temperature values occur, the machines 110, 112 send a trigger message 134 to the network 104. The machines 110, 112 may include transceiver circuits that transmit and/or receive information or messages to/from the network 104. In other examples, the machines 110, 112 couple to separate transceiver circuits that are physically separate from the machines 110, 112.

The trigger message 134 may be any type of electronic message that causes the apparatus 120 to create a hyperlink for presentation to a user. The trigger message 134 may be according to any format or protocol.

The trigger message 134, in some examples, identifies the machine and includes information identifying the problem that triggered issuance of the alert (e.g., the temperature of the machine exceeded a predetermined temperature threshold). In these regards, alerts may be issued when one or more operating parameters of the machines exceed or fall below predetermined thresholds. In examples, the alerts may be to Predix alerts (from the Predix system manufactured by the General Electric Company). Such alerts include Predix-specific information. Although only two sensors 130 and 132 are shown in the example of FIG. 1, it will be appreciated that any number of sensors may be deployed at the machines 110, 112.

The network 104 may be any network or combination of networks. In examples, the network 104 may be the cloud, the internet, cellular networks, local or wide area networks, or any combination of these (or other) networks. The network 104 may include various electronic devices (e.g., routers, gateways, and/or processors to mention a few examples).

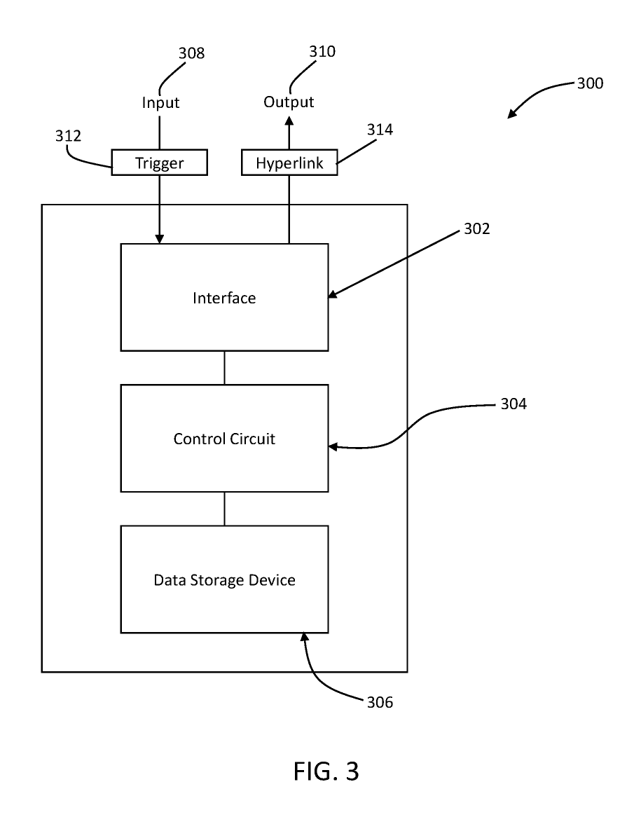

The central processing center 106 may include a processing apparatus 120 (e.g., including a control circuit 304 (see FIG. 3)) that performs various processing functions. The central processing center 106 may also include or be coupled to electronic devices 122 (e.g., personal computers, smart phones, laptops, or tablets) that allow a user to enter data that will be processed by the central processing apparatus 120. The central processing center 106 renders a risk assessment 138 to be sent to the network 104, and ultimately sent to a user at a user display device 108.

The user display device 108 is any type of device that displays data in a visually accessible manner to a user, such as a matrix. In examples, the device 108 is a computer or smart phone. Other examples are possible. It will be appreciated that the user display device 108 may be deployed outside the installation 102 (as shown in FIG. 1), but may also be deployed within the installation 102. For example, a user with a smartphone may desire to view the risk assessment as the user walks through the installation 102. In other examples, the user display device 108 is a personal computer deployed at the installation (e.g., at a factory, school, or business).

In one example of the operation of the system of FIG. 1, a risk assessment associated with industrial machines 110 or 112 (or components of these machine) is performed by the apparatus 120 at the central processing center 106. The trigger 134 (e.g., an alert message) is received from one of the industrial machines 110 or 112. When the trigger 134 is received, a hyperlink is dynamically rendered to a user at a user display device 108. A user selects the hyperlink. When the hyperlink is selected by the user, a dynamic risk assessment display 114 is rendered on the user display device 108 to the user, and the risk assessment display 114 communicates the risk assessment.

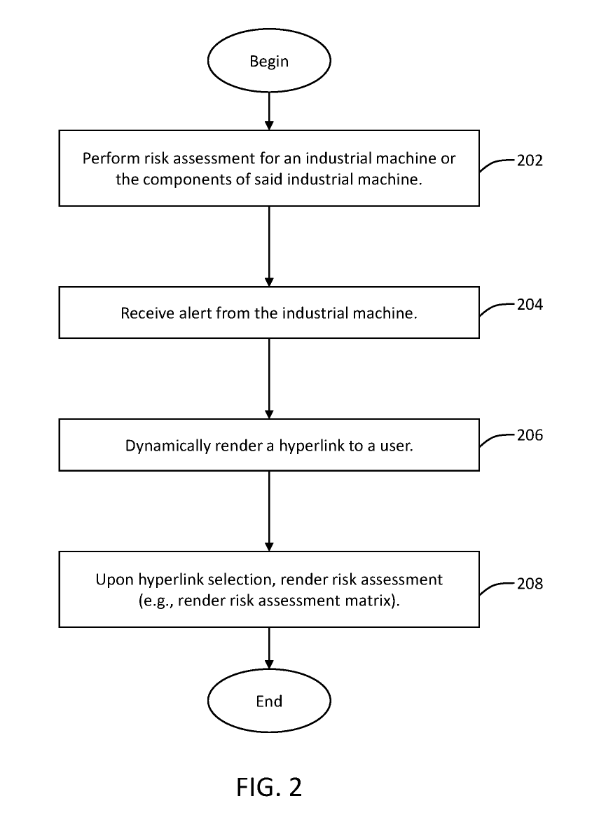

Referring now to FIG. 2, one example of an approach for assessing and displaying views of risk associated with industrial machines is described. In this example, a machine couples to a network, and the network is coupled to a central processing center. A user display device also couples to the network. The user display device may be deployed near the machine (e.g., at an installation where the machine is deployed), or remotely from the machine. In some cases, the user display device may be deployed at the central processing center.

At step 202, a risk assessment analysis is performed for an industrial machine (or the components of the industrial machine) at the central processing center. In examples, risk assessments may weigh whether a machine is likely to fail (e.g., using a numeric scale), and whether the component is sensitive or delicate (e.g., whether the component is susceptible to easy breakage because of its size or composition). In other examples, risk assessments involve the consequences of machine or component failure. For instance, failure of the component may cause the machine to fail. In other examples, failure of the machine may cause an entire process to cease functioning (e.g., shutdown an entire assembly line or reactor).

In any case, dynamic real time data is received at the central processing center (e.g., from the machine) and used, at least in part, to determine a risk assessment for the machine. Real time data that indicates failures (or impending failures) can be utilized. For instance, sensed temperature data indicating temperatures that are trending higher (e.g., towards a predetermined critical temperature threshold) may be received continuously (and in real time) from the machine. In other examples, components are changed at the machine as maintenance is performed. As components are changed out, risks associated with the machines will potentially change. For instance, a more structurally robust component may be inserted into the machine to replace a more delicate component.

At step 204, the industrial machine transmits a trigger message (e.g., indicating potential failure) over the network to the central processing center. The trigger message is any type of information that will cause a hyperlink to be created at the central processing center. For example, the trigger message may be an alert message (that some parameter has reached a predetermined threshold). In other example, the trigger message may simply be a reminder issued at certain time intervals for a user to view risk assessments.

At step 206, a hyperlink is dynamically created by the central processing center and transmitted over the network to a user at a user display device. The hyperlink is then received from the network at the user display device.

At step 208, the user selects the hyperlink. The user may make the selection by a variety of different ways, such as using a computer mouse to click on the hyperlink. Selection of the hyperlink is received at the central processing center. A risk assessment display is created at the central processing center, and the risk assessment display is sent over the network to the user device for rendering to the user.

The risk assessment display is configured and structured so that users can quickly and easily determine the nature and urgency of a risk. For example, the probability of a machine failing can be plotted against consequences of a failure in the form of a graph to allow the user to make a determination as to an action (if required). For example, if the risk of failure is high and the consequences for failure high, the user can proceed with an emergency replacement operation. In other examples, when the risk of failure is low, and the consequences of a failure low, then the user may decide to wait to examine a machine during routine scheduled maintenance operations.

Referring now to FIG. 3, one example of an apparatus 300 that is configured to create hyperlinks and risk assessments is described. The apparatus 300 includes an interface 302, a control circuit 304, and a data storage device 306. The interface 302 has an input 308 configured to receive a trigger message 312 from the industrial machines. The interface 302 also includes an output 310 configured to send the hyperlink 314 to a user at a user display device.

The control circuit 304 may be a processor for processing data associated with the trigger message 312. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 304 may be configured (for example, by using corresponding programming stored in a memory as will be well understood by those skilled in the art) to carry out one or more of the steps, actions, and/or functions described herein. The data storage device 306 can be any type of memory, and may contain, for example, historical data and/or time series.

In one example of the operation of the apparatus of FIG. 3, the interface 302 receives an input 308 from a network (e.g., the network 104 of FIG. 1) in the form of data associated with the trigger message 312. The control circuit processes said message 312, where it is then stored in the data storage device 306. The hyperlink 314 is dynamically rendered by the control circuit 304 and the hyperlink 314 is sent as an output 310 to the network.

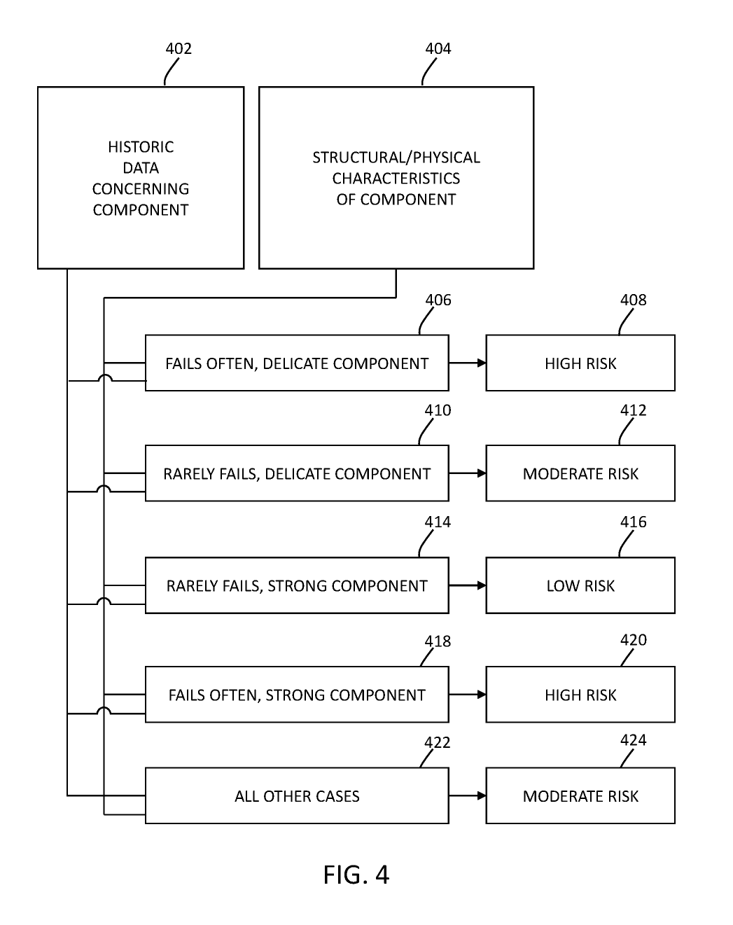

Referring now to FIG. 4, one example of an approach for determining the relative amount of risk that a component or machine will fail is described. The machine (or component) may be identified in different ways, for example, by a message from the machine (e.g., the trigger information 134 of FIG. 1), or from user input.

Historic data 402 may be stored in a data storage device at a central processing center (e.g., at a storage device within apparatus 120 at the central processing center 106 of FIG. 1). The historic data 402 may be updated in real time as new data arrives from the machines. Historical data may indicate time between failures, in one example. In other examples, the historic data may be time series data concerning one or more parameters (e.g., temperature) measured at the machine. Again, the historic data may be updated in real time in some aspects.

Structures and physical characteristics information 404 include information concerning the physical strength of components. As with the historic data 402, the information 404 may be stored at a data storage device at the central processing center (e.g., at a storage device within apparatus 120 at the central processing center 106 of FIG. 1). In examples, this information 404 may indicate that the component is structurally strong or structurally weak. The information 404 may be entered, in one example, manually, in real time as components changed during maintenance operations.

Based upon an evaluation of the historic data 402 and structures and physical characteristics information 404, a determination is made of whether there is a high 408, moderate 412, or low risk 416 of machine failure. In these regards, the data 402 and information 404 may be weighted in determining a failure. For example, the mean time between failures may be seen to be more important than structural characteristics in the determination of how high there is a risk for machine failure. In other examples, structural characteristics may be seen as more important. In aspects, the relative risks are assigned an integer number according to a scale of 1-10. For instance, high risk 408 may be 8-10, moderate risk may be 4-7, and low risk 416 may be 1-3.

In this example, risk evaluation steps 406, 410, 414, 418, and 422 weigh how often the machine (or component) has historically failed (or is likely to fail) and the robustness of the component, and assign a risk of failure (high, moderate, or low) based upon the evaluation. More specifically, at step 406 when the part fails often (e.g., more than once during a predetermined time period) and the part is not robust (e.g., as indicated by a user), then this machine (or component) is assigned a high risk designation at step 408.

At step 410, it is determined that machine (or component) is delicate and rarely fails. A moderate risk is assigned to the machine (or component) at step 412.

At step 414, it is determined that the machine (or component) is structurally strong and rarely fails. At step 416, a low risk designation is assigned to the machine (or component).

At step 418, it is determined that the machine (or component) is structurally strong and fails often. Consequently, at step 420 a high risk designation is assigned to the machine (or component).

At step 422, some other combination of time-between failures and structural robustness is determined to exist (e.g., a time between failures that is between rare and often). In this case, a moderate risk is assigned to the machine (or component) at step 424.

Once determined, the risk of failure can be visually presented to a user in a convenient manner so that the user can take actions to prevent machine failure, if needed.

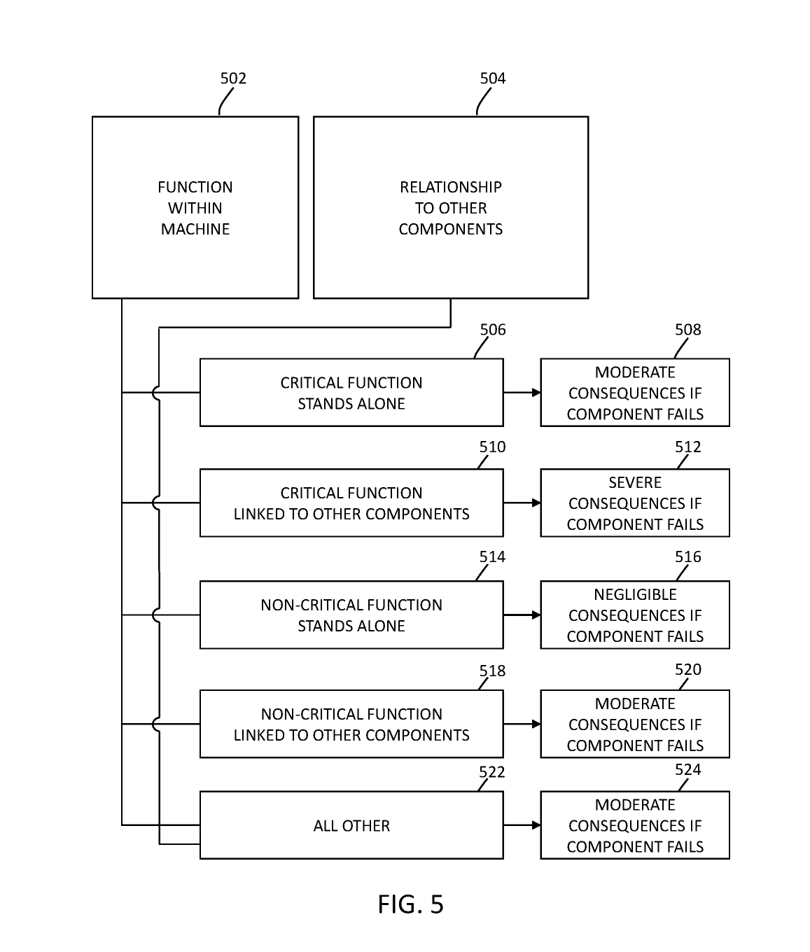

Referring now to FIG. 5, one example of an approach for evaluating the severity of the consequences associated with machine and/or component failure is described. The machine (or component) may be identified in different ways, for example, by a message from the machine (e.g., the trigger information 134 of FIG. 1), or from user input.

The severity of the consequences is determined, in this example, by examining criticality information 502 of the machine (or component) and the relationship information 504 of the machine (or component), and a severity of consequences for machine (or component failure) may be determined. The criticality information 502 and relationship information 504 may be stored in a data storage device at the central processing center (e.g., at a storage device within apparatus 120 at the central processing center 106 of FIG. 1). The criticality information 502 and relationship information 504 may be entered manually and in real time. In other words, the criticality information 502 and relationship information 504 may change over time (e.g., as new machines and/or components are used).

The criticality information 502 indicates whether the function of the machine (or component) is critical or non-critical. For example, in a manufacturing operation some machines may perform critical functions, while other machines perform optional functions. The relationship information 504 indicates how integrated the machine (or component) is with other machines (or components). For example, a machine (or component) may stand alone. In another example, the machine (or component) may be extensively inter-linked with other machines (or components). Numerical values can be assigned to both the criticality information 502 and the relationship information 504.

Based upon the evaluation of the criticality information 502 and the relationship information 504 at steps 506, 510, 514, 518, and 522, the severity of the consequences is determined at steps 508, 512, 516, 520, and 524. Consequences are deemed “severe,” “moderate,” and “negligible.” By “severe” it is meant that there are severe consequences of a failure. By “moderate” it is meant that there are moderate consequences of a failure. Finally, by “negligible” it is meant that there are few if any consequences of a failure. The determined consequences can be assigned a numeric value such as an integer value.

At step 506, it is determined that the function of the machine (or component) is critical (as indicated by a user) and stands alone from other components (as indicated by a user, or by evaluating other information such as blueprints of a factory). Consequently, at step 508, a moderate consequences for failure designation is assigned.

At step 510, it is determined that the component is critical and is linked to other components. Then, at step 512, a severe consequences for failure designation is assigned.

At step 514, it is determined that the machine (or component) is non-critical and stands alone from other machines (or components). Then, at step 516, a negligible consequences of failure designation is assigned.

At step 518, it is determined that the machine (or component) is non-critical and is linked to other components. Then, at step 520, a moderate consequences for failure designation is assigned.

At step 522, it is determined that some other combination of criticality information 502 and relationship information 504 exists. Then, at step 524, a moderate consequences for failure designation is assigned.

Once determined, the consequences of failure can be visually presented to a user in a convenient manner (and with or without other risk information such as the risk of failure information obtained according to the approach of FIG. 4) so that the user can take actions to prevent machine failure, if needed.

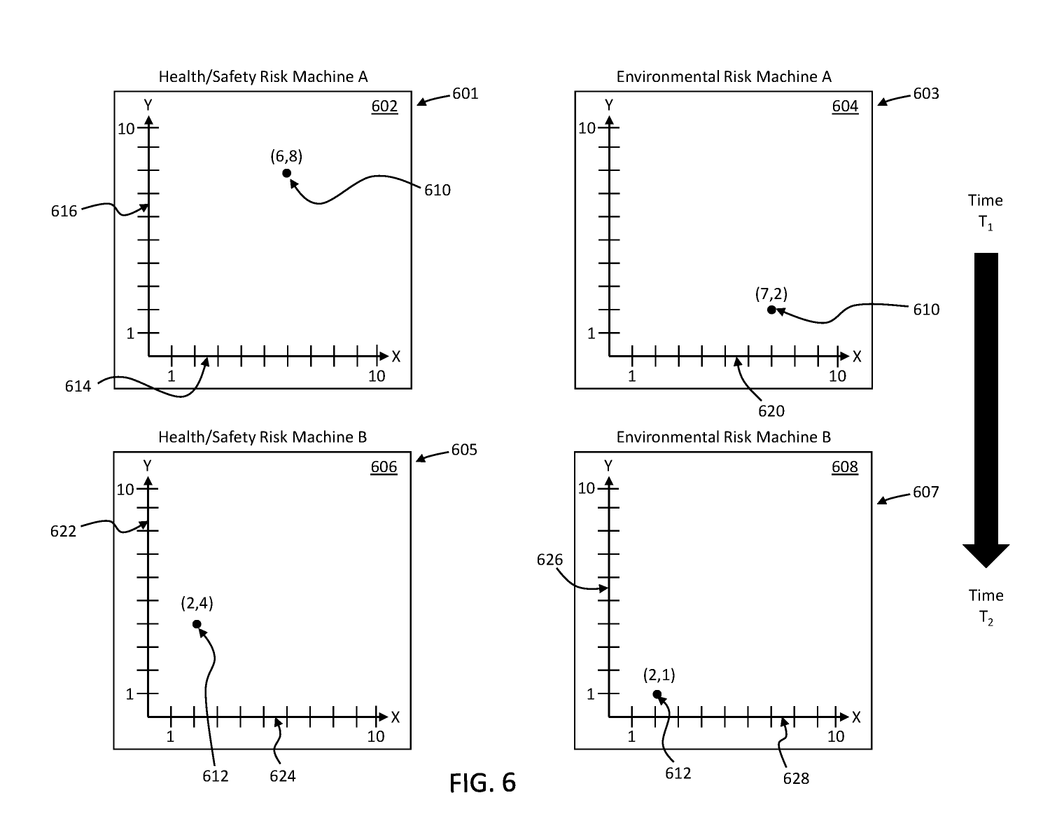

Referring now to FIG. 6, one example of displays (e.g., matrices) rendered on a user display device (e.g., user display device 108 of FIG. 1) to a user is described.

In this example, when the user selects a hyperlink, dynamic risk assessment displays 601 and 603 are rendered to the user as a set of matrices 602 and 604. Each matrix 602, 604 has an x-axis 614, 620 representing the risk (e.g., probability) of a machine (or component) failure (e.g., obtained using the approach of FIG. 4), and a y-axis 616, 618 representing the severity of the consequences of such a failure (e.g., obtained using the approach of FIG. 5). In other examples, the x- and y-axis can be reversed such that y-axis represents the risk of a machine (or component) failure, and the x-axis represents the severity of the consequences of such a failure.

In this example, both the x-axis 614, 620 and the y-axis 616, 618 span an integer range of 1-10 designated by tick marks along the axis. For example, an x-axis value of 1 represents a very low probability of a machine (or component) failing, while, at the other extreme, an x-axis value of 10 represents a high risk of a machine (or component) failing. Further, a y-axis value of 1 designates a very low consequence of such a failure, while a y-axis value of 10 designates a severe consequence of failure.

A particular risk for a particular machine (or component) at a particular moment in time is represented by a point 610 on each matrix 602 or 604. The point 610 indicates the determined risk of failure as an x-coordinate versus the severity of the consequences as a y-coordinate. In this way, the point 610 will have a particular set of x-y coordinates and a user can quickly and easily view risk, and take actions as needed. Additionally, the displays may be updated in real time as the information used to construct the displays.

In this example, point 610 in display 601 has x-y coordinates (6,8) representing a higher than average degree of risk of failure and fairly severe consequences. In this situation, a user may wish to take emergency action to service or maintain a machine (or component). On the other hand, point 610 in display 603 has x-y coordinates (7,2) representing a slightly higher risk of failure than shown by the display 601, but non-severe consequences of failure. Thus, a user may wish to service the machine (or component) within the next week (compared to immediately).

Each particular matrix 602, 604 is a visualization of two separate types of risk: health/safety risks (in matrix 602) and environmental risks (in matrix 604). Both matrices 602 and 604 are associated with risks for a machine A at a time T1. Other types of risk are possible. In other words, there may be more than one type of risk and these different types may include information that is rendered to a user.

At a later time, T2, risk assessments for a different machine are displayed as matrices 606, 608 (which are a part of displays 605 and 607). The displays 601 and 603 may be taken off the screen to show the displays 605 and 607. In other examples, the displays, once rendered remain on the screen and are updated in real-time as new inputs are received.

In one example, these new displays 605, 607 are rendered when an alert pertaining to a machine B is received at a central processing center (e.g., central processing center 106 of FIG. 1) at time T2. Similar to matrices 602, 604, the x-axis 624 represents the risk (e.g., probability) with machine B, and the y-axis 622 represents the consequences if failure occurs. In this example, matrix 606 shows the health/safety risks for machine B, while the matrix 608 shows the environmental risk parameter risks for machine B (612), both at a time T2.

As with the matrices 602 and 604, the point 610 indicates the risk of failure as an x-coordinate versus the severity of the consequences as a y-coordinate. In this way, a user can quickly and easily view risk, and take actions as needed. Additionally, the displays may be updated in real time as the information used to construct the displays.

In this example, point 612 in display 606 has x-y coordinates (2,4) representing a low degree of risk of failure and somewhat moderate (slightly less than average) consequences for the machine B. Point 612 in display 608 has x-y coordinates (2,1) representing a low degree of risk of failure and very low consequences for the machine B. In this case, a user may not need to service the machine (or component) in the near future, but may want to monitor the machine for changes in probability and severity.

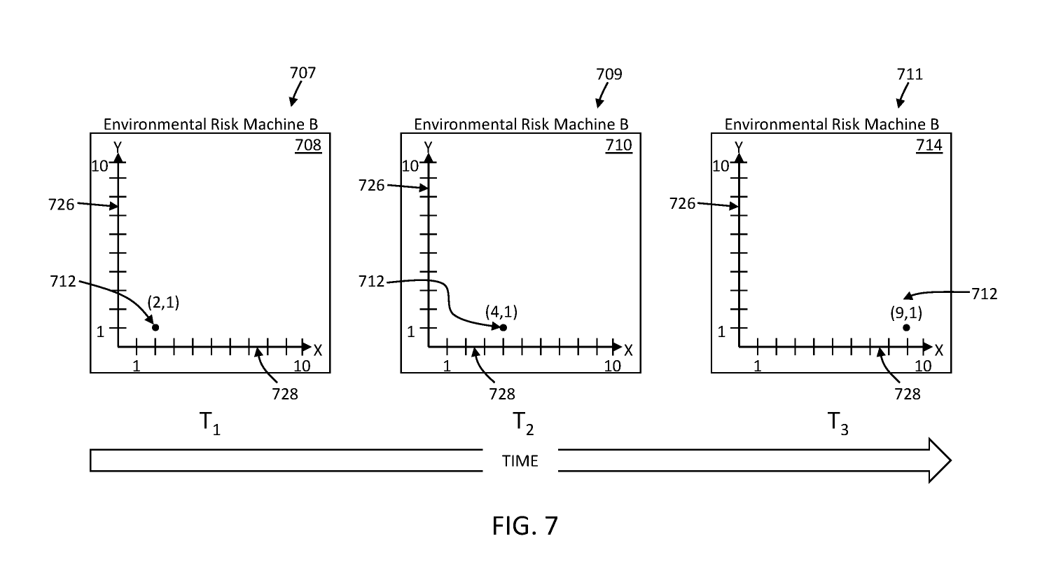

Referring now to FIG. 7, another example of risk assessment displays (e.g., matrices) rendered on a user display device (e.g., user display device 108 of FIG. 1) to a user is described. In the previous examples of FIG. 6, risk of failure of a machine components versus the consequences of the failure was presented for one particular machine at a particular time (machine A at time T1) and another machine at a different time (machine B at time T2). In other aspects, it may also be advantageous to monitor how the risk of failure changes for a particular machine as a function of time.

In these regards and in the example of FIG. 7, when a user selects a hyperlink the dynamic risk assessment display 707 is rendered to the user as a matrix 708 at a time T1. Similar to matrix 608 of FIG. 6, an x-axis 728 represents the risk (e.g., probability) of failure of machine B, and a y-axis 726 represents the consequences if failure should occur. A point 712 with x-y coordinates (2, 1) represents a low degree of risk of failure and very low consequences for failure. The displays shown in FIG. 7 are for one type of risk: environmental risk.

At a later time T2, a display 709 is rendered to the user as a matrix 710. Point 712 has moved and now has x-y coordinates (4,1) designating a slightly higher probability of failure for the machine B shown in matrix 708, but with the same consequences associated with the failure. At a still later time T3, a display 711 is rendered to the user as a matrix 714 and the point 712 changed locations and now has x-y coordinates (9,1). The placement of the point 712 indicates a very high probability of failure for the same machine B. Thus, after viewing all three displays sequentially, across time and given the trending risk assessments shown by these displays, a user may wish to service the machine B immediately since over time the probability of failure of the machine B has drastically increased.

In aspects, the displays 707, 709, and 711 are displayed to a user sequentially. In this case, the user only sees the point 712 move. The point 712 moves because the underlying data (e.g., time between failures, machine specifications, criticality of machine function, and interrelation of the machine to other machines) that defines the point has changed.

Taking the examples of FIG. 6 and FIG. 7 together, it can be seen that a user can quickly, easily, and efficiently assess the risk and consequences of failure for a machine. Various factors (e.g., time between failures, machine specifications, criticality of machine function, and interrelation of the machine to other machines) that change in real-time are obtained, and these factors analyzed and processed to create displays (that are changeable in real-time) showing the chance of failure versus the consequences of failure. It will further be seen that the separate types of failure (e.g., environmental and economic) may be presented as separate graphs.

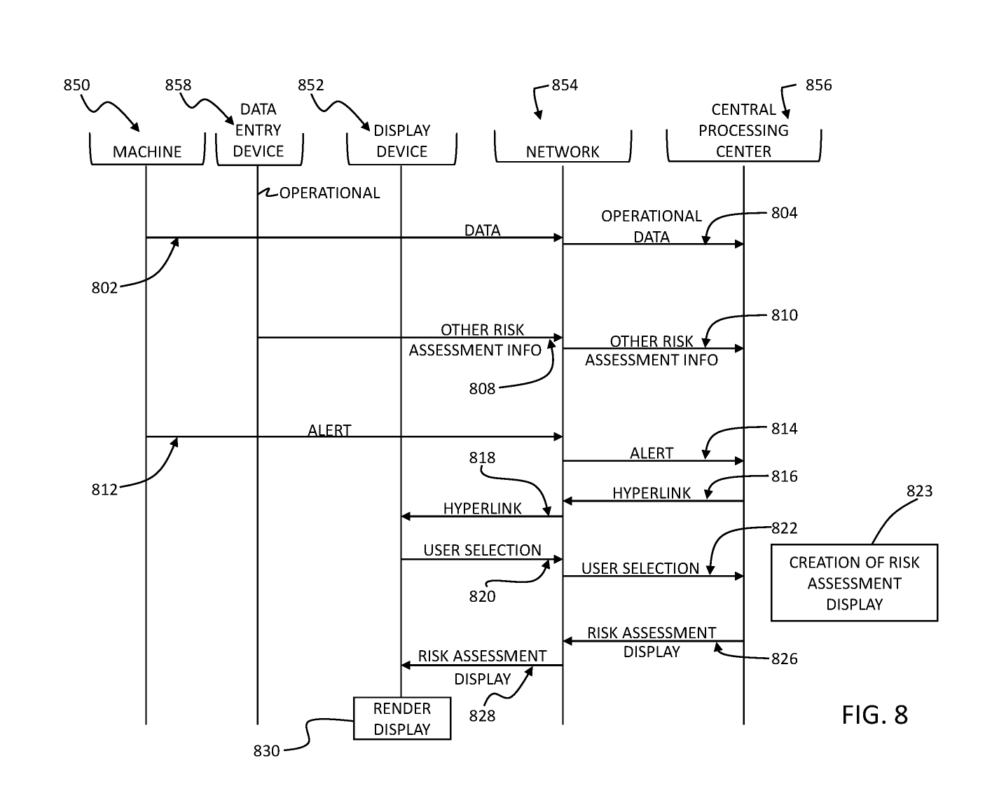

Referring now to FIG. 8, the flow of communications between system elements (e.g., the system of FIG. 1) is described. The system includes a machine 850, a user display device 852, a network 854, and a central processing center 856.

At step 802, operational data concerning the operation of a machine 850 (or machine component) is sent to the network 854. The operational data pertains to, in this example, the frequency of failure of the machine 850. For example, the data may indicate an actual failure at the machine. In other examples, the data may indicate the machine is approaching failure (e.g., the temperature of the machine is reaching a critical threshold).

At step 804, the network sends the data to the central processing center 856. Once received at the central processing center, the data may be stored as historical data in a data storage device.

At step 808, additional risk assessment information is sent to the network from the machine 850 or a data entry device 858. For example, structural characteristics of a machine (or components), the criticality of the function of the machine (or component), and the severity of the consequences of the machine (or component) may be received. This information may be received from the machine 850 or a data entry device 858. At step 810, the additional risk assessment information is received, processed and stored at the central processor 106 in the same manner as the above description.

At step 812, an alert (or some other trigger message) is sent to the network 854 from the machine 850. At step 814, the network 854 sends the alert to the central processing center 856.

In response, the central processing center 856 creates a dynamic hyperlink 314, and at step 816 transmits the hyperlink to the network 854. At step 818, the hyperlink is sent from the network 854 to the user display device 852.

At the display device 852, the user selects the hyperlink, and the selection is sent to the network 854 at step 820. At step 822, the hyperlink is then sent from the network 854 to the central processing station 856.

At step 823, a risk assessment display is constructed at the central processing center 856. The assessment may, in aspects, be created according to the approaches described in FIG. 4 and FIG. 5, and be in the form of a matrix as shown in FIG. 6 or FIG. 7. The display may be in any format or according to any protocol.

At step 826, the display is sent from the central processing center 856 to the network 854. At step 828, the display is sent from the network 854 to the user display device 852. At step 830, the display is rendered on the screen of the user display device.

It will be appreciated by those skilled in the art that modifications to the foregoing embodiments may be made in various aspects. Other variations clearly would also work, and are within the scope and spirit of the invention. It is deemed that the spirit and scope of the invention encompasses such modifications and alterations to the embodiments herein as would be apparent to one of ordinary skill in the art and familiar with the teachings of the present application.

What is claimed is:

1. A method of assessing risk failures of industrial machines, the method comprising:
performing a risk assessment associated with an industrial machine or component of the machine;
receiving a trigger message from the industrial machine;
when the trigger message is received, dynamically rendering a hyperlink to a user on a display;
selecting the hyperlink by a user;
when the hyperlink is selected by the user, rendering a dynamic risk assessment display on a display device to the user, the risk assessment display communicating the risk assessment.

2. The method of claim 1, wherein the risk assessment display is a matrix.

3. The method of claim 2, wherein the matrix has an x-axis representing the probability of having a problem and the y-axis represents the consequence if the problem occurs.

4. The method of claim 1, wherein the display device is a computer or smart phone.

5. The method of claim 1, wherein the risk is an environmental, financial, operational, health, or safety risk.

6. The method of claim 1, wherein the steps are performed at a central processing center.

7. The method of claim 6, wherein the trigger message is sent over the cloud to the central processing center.

8. An apparatus configured to determine the risk of failure of an industrial machine or components of a machine, the apparatus comprising:
an interface having an input and output, the input being configured to receiving a trigger message from an industrial machine;
a control circuit coupled to the interface, the control circuit configured to determine a risk assessment, and, upon receiving the trigger message, dynamically render a hyperlink to a user via the output of the interface, receive a selection of the hyperlink by the user via the input of the interface, and when the hyperlink is selected by the user, render a dynamic risk assessment display defining the risk assessment on a display device to the user via the output of the interface.

9. The apparatus of claim 8, wherein the risk assessment display is a matrix.

10. The apparatus of claim 9, wherein the matrix has an x-axis representing the probability of having a problem and the y-axis represents the consequence if the problem occurs.

11. The apparatus of claim 8, wherein the display device is a computer or smart phone.

12. The apparatus of claim 8, wherein the risk is an environmental, financial, operational, health, or safety risk.

13. The apparatus of claim 8, wherein the steps are performed at a central processing center.

14. The apparatus of claim 13, wherein the trigger message is sent over the cloud to the central processing center.

15. The apparatus of claim 8, wherein the hyperlink is received on a computer or smart phone from the cloud.

16. The apparatus of claim 8, wherein data associated with the matrix is stored in the cloud.

17. The apparatus of claim 16, wherein the risk assessment matrix data is received on a computer or smart phone from the cloud.
